(19) United States
(12) Patent Application Publication
(10) Pub. No.: US 2006/0072009 A1
(43) Pub. Date: Apr. 6, 2006

(54) Flexible interaction-based computer interfacing using visible artifacts

(75) Inventors: Frederik Carl Moesgaard Kjeldsen, Poughkeepsie, NY (US); Anthony Tom Levas, Yorktown Heights, NY (US); Gopal Sarma Pingali, Mohegan Lake, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 10/957,123

(22) Filed: Oct. 1, 2004

(51) Int. Cl. H04N 7/18

(52) U.S. Cl. 348/137

(57) ABSTRACT

An exemplary technique for interaction-based computer interfacing comprises determining if an interaction with a visible artifact is a recognized interaction. When the interaction is a recognized interaction, control information is determined that has one of a plurality of types. The control information is determined by using at least the visual artifact and characteristics of the recognized interaction. The control information is mapped to one or more tasks in an application, such that any task that requires control information of a specific type can get the control information from any visual artifact that creates control information of the specific type. The control information is suitable for use by the one or more tasks.

### FIELD OF THE INVENTION

The present invention relates generally to techniques for human interfacing with computer systems, and more particularly, to techniques for camera-based interfacing with a computer system.

### BACKGROUND OF THE INVENTION

Camera-based interfacing with a computer system has become more important lately, as computer systems have become fast enough to analyze and react to what appears on video generated by the camera. Additionally, cameras have become more inexpensive and will likely continue to drop in price.

In camera-based interfacing with a computer system, a user will either gesticulate in free space, or interact directly with a visible artifact such as an object or projected image. The user may perform semantically meaningful gestures, move or interact with an object or pantomime a physical action. The camera captures images of the user and their immediate environment and then a computer system to which the camera is coupled examines video from the camera. The computer system can determine that the user is performing an interaction such as a gesture and then can perform functions related to the interaction.

For example, the computer may follow a link in a projected web page when the user touches that region of the projection. The computer system can then output the target of the link to the projector so that it can update the projected image.

Camera-based interaction has the potential to be very flexible, where the user is not tied to complex, single purpose hardware and the interface is not limited to mouse or keystroke input. However, in current camera-based systems, it is the system designer that defines a specific set of interactions, and potentially where these interactions must be performed. This can make it difficult to tailor the system to a new environment, and does not allow the user to customize the interface to their needs or limitations.

### SUMMARY OF THE INVENTION

Generally, the present invention provides techniques for interaction-based computer interfacing.

An exemplary technique for interaction-based computer interfacing comprises determining if an interaction with a visible artifact is a recognized interaction. When the interaction is a recognized interaction, control information is determined that has one of a plurality of types. The control information is determined by using at least the visual artifact and characteristics of the recognized interaction. The control information is mapped to one or more tasks in an application, such that any task that requires control information of a specific type can get the control information from any visual artifact that creates control information of the specific type. The control information is suitable for use by the one or more tasks.

A more complete understanding of the present invention, as well as further features and advantages of the present invention, will be obtained by reference to the following detailed description and drawings.

### BRIEF DESCRIPTION OF THE DRAWING

FIG. 1 shows a block diagram of a computer vision system interfacing, through a camera and a projector, with a user in a defined area, in accordance with an exemplary embodiment of the present invention;

FIG. 2 shows a block diagram of an exemplary computer vision system in accordance with an exemplary embodiment of the present invention;

FIG. 3 is a flow chart of an exemplary method for training a computer vision system to determine recognized visible artifacts, recognized interactions for those recognized visible artifacts, and types for the recognized interactions according to user preferences and to produce corresponding control information and appropriate mapping suitable for communicating to a task of an application residing in a computer system; and

FIG. 4 is a flow chart of an exemplary method for normal use of a computer vision system to determine recognized interactions and corresponding types for a given visible artifact and to produce corresponding control information suitable for communicating to an application residing in a computer system.

### DETAILED DESCRIPTION

Camera-based interfacing with a computer system is a desirable form of computer input because this interfacing offers far more flexibility and expressiveness than fixed input hardware, such as keyboards and mice. This allows the interfacing to be better tailored to the needs of a user and an associated application resident in the computer system. As described herein, the interfacing also provides the potential for users to tailor interaction to suit their physical needs or the constraints of a current environment in which the computer system exists.

For example, if a user is showing a document to several colleagues by projecting the document on a large screen, she may want to configure a computer system so that the document scrolls based on a movement of her arm over the projection, rather than by forcing her to return to the computer console and using the mouse to manipulate a scroll bar.

This type of flexibility will be particularly important for users with physical limitations. People who are unable to use fixed interface hardware, such as a keyboard or mouse can define an interface which matches their abilities.

In current camera-based interfacing, a fixed set of interactions such as gestures can be created by an application designer to control the application at any point. These approaches are similar to traditional computer interfaces and do not allow the user to take advantage of the flexibility inherent in camera interfacing, limiting the utility of these approaches. A solution is proposed herein that gives the users the ability to layout the interface to their needs using visible artifacts as markers.

Consequently, exemplary embodiments of the present invention allow an object, typically a portion of a human or controlled by a human or both, to interact with a visible artifact. A visible artifact can be, for instance, any type of physical object, printed pages having images, projected images, or any combination thereof. The interaction and the visible artifact are viewed by a camera, which provides an input into a computer vision system. An interaction is any action performed by an object near a visible artifact. Typically, an interaction is a gesture performed by a user. The computer vision system will determine whether the interaction is a recognized interaction and extract information about the details of the interaction. The artifact and this extracted information is used to determine control information suitable for outputting to one or more tasks in an application to which the computer vision system can communicate. This control information has one of a plurality of types, and specific parameters of the control information are determined by characteristics of the information extracted from the interaction. Generally, the application resides in the computer vision system itself, although the application could reside in a computer system separate from the computer vision system. An application is any set of instructions able to be executed by a computer system and a task is some function performed or able to be performed by the application.

The different types of the control information are a mechanism to summarize important aspects of an interaction such as a gesture. An example set of types can be zero-dimensional, one-dimensional, two-dimensional, or three-dimensional. Control information can comprise a control signal that corresponds to the type. For instance, a zero-dimensional control signal is a binary signal that might trigger an action in an application. A zero dimensional control signal might be generated by a user touching an artifact. A one-dimensional control signal is a value for a continuous parameter. A one-dimensional control signal might be generated by the location along a visual artifact where the user touched. In an exemplary embodiment, an application would list the types of control information required for a task, and each visual artifact would have one or more types of control information that can be produced.

The control information generated by visual artifacts would be mapped to application tasks when an interface is defined during training. An application generally has a number of initiated tasks the application can perform at any point in time. To work most seamlessly with certain embodiments of this invention, an application would publish a list of the type of inputs the application needs to initiate or control each task, so that the system can map control information to these inputs. This invention is also able to work with applications that do not publish such a list, though often not as smoothly, by simulating the type of inputs the application typically gets from the user or operating system (e.g., mouse click events).

The computer vision system can be trained for different visible artifacts, different interactions associated with the visible artifacts, different characteristics of those interactions, different control information corresponding to a visible artifact and an associated interaction, and different mappings of that control information to tasks. Importantly, in one embodiment, a single visible artifact and a given interaction with that visible artifact can differ in any of the ways described in the previous sentence depending on the location of the visible artifact, the state of the application, or other contextual information. For example, if the visible artifact is located at one location, hitting the visible artifact could cause one action (e.g., turning off an alarm) to be produced, but if the visible artifact is located in another location, hitting the visible artifact could cause another action to be produced (e.g., causing the default option for a window to be accepted). If an application has a help window open (e.g., and is in a state indicating that the help window is functioning), control information might be mapped to a task (such as selecting from a list of contents) for the help window. Conversely, if the application is executing in a normal state, control information might be mapped to a different task (such as selecting a menu corresponding to a toolbar) associated with the application. Furthermore, in certain embodiments, the computer vision system can determine recognized visible artifacts by locating visible artifacts in a defined area (e.g., by searching for the visible artifacts) and learning, with user interfacing, which visible artifacts are to be used with which interactions.

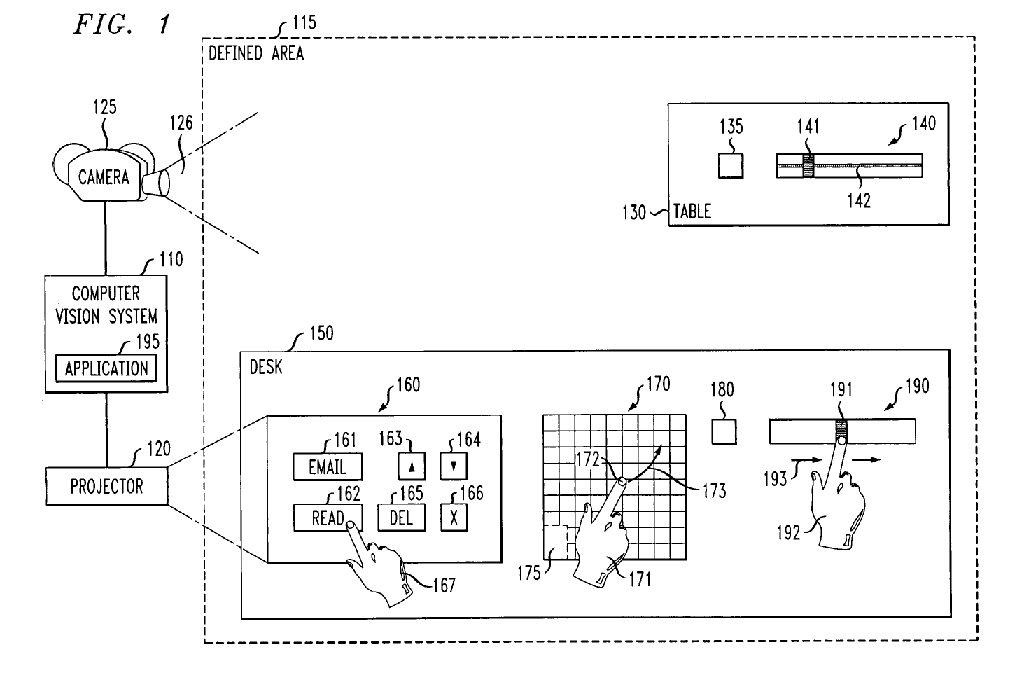

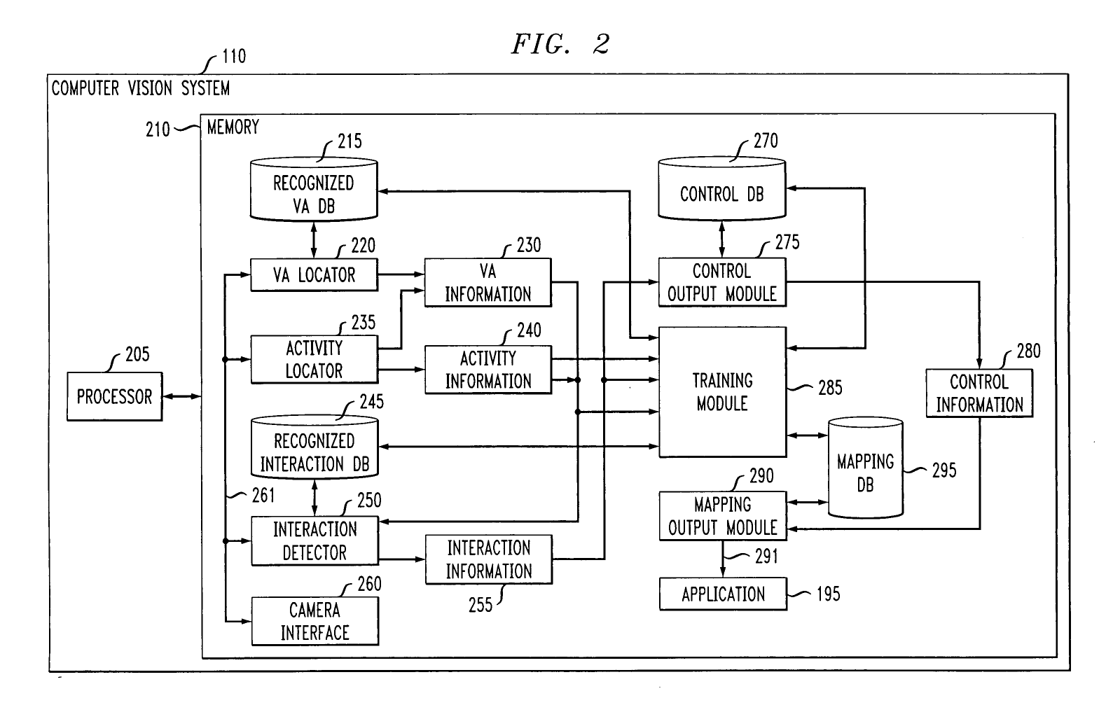

Turning now to FIG. 1, a computer vision system 110 is shown interfacing, through a camera 125 and a projector 120, with a defined area 115, in accordance with an exemplary embodiment of the present invention. The computer vision system 110 is coupled to the camera 125 and to the projector 120. An exemplary computer vision system 110 is shown in FIG. 2. In the example of FIG. 1, the camera 125 and projector 120 are not part of the computer vision system 110, although the computer vision system 110 can include the camera 125 and the projector 120, if desired. The defined area 115 is an area viewable by the camera 125, which typically will have a pan and tilt system (not shown) and perhaps zoom capability so that the field of view 126 can include all of defined area 115. Although only one projector 120 and one camera 125 are shown, any number of projectors 120 and cameras 125 may be used.

There is a table 130 and a desk 150 in the defined area 115. On the table 130, a user has placed a small note paper 135 and a physical scroll bar 140. The physical scroll bar is an object having a slider 141 that communicates with and may be slid in groove 192. On the desk 150, the user has placed a grid pad 170 and a small note paper 180. The projector is used to project the image 160 and the image 190. The image 160 is an image having buttons related to an email program (i.e., an application) resident in the computer vision system 100. The image 160 comprises an email button 161, a read button 162, an up button 163, a down button 164, a delete button 165 and a close window button 166. The image 190 is a scroll bar having a slider 191.

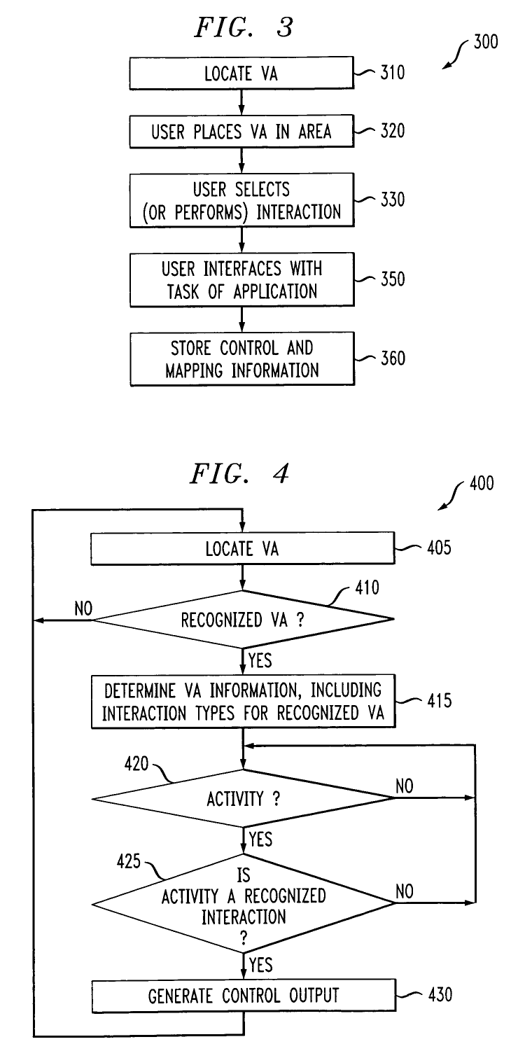

The small note paper 135, a physical scroll bar 140, the grid pad 170, the small note paper 180, and the images 160, 190 are recognized visible artifacts. Recognized visible artifacts are those visible artifacts that the computer vision system 110 has been taught to recognize. The table 130 and desk 150 are also visible artifacts, but the table 130 and the desk 150 are not recognized visible artifacts. The user has gone through a teaching process (described below) in order to place each of the visible artifacts at particular locations, to allow the computer vision system 110 to determine information about the visible artifacts in order to locate the visible artifacts, and to interface with an application 195 also running on the computer vision system 110. This is described in further detail in reference to FIG. 3. It should be noted that the application 195 can be resident in a computer system separate from the computer vision system 110.

When a user interacts with the image 160 by (for example) touching a button 161-166, the computer vision system 110 will determine information (not shown in FIG. 1) corresponding to the selected button and to the interaction. The information can be determined through techniques known to those skilled in the art. Control information is determined using the information about the selected button and the interaction. The control information is then typically communicated to an associated application 195. The interaction is therefore touching a button 161-166. In reference to the image 160, when an interaction occurs with email button 161, the control information can comprise a zero dimensional signal that is then interpreted by an operating system (an application 195 in this example) to execute an email program resident in the computer vision system 110 (e.g., resident in memory 210 of and executed by processor 205 of FIG. 2).

Interacting by the hand 167 with the read button 162 causes the computer vision system 100 to communicate a signal to the read task of the opened email program (e.g., an application 195), which causes a selected email to be opened. Interaction with the up button 163 causes the computer vision system 110 to communicate a signal to the up task of the email program (as application 195). The email program, application 195, can respond to the signal by moving a selection upward through a list of emails. Similarly, interaction with the down button 164 causes the computer vision system 110 to communicate a signal to the down task of the email program (as application 195). The email program, application 195, can respond to the signal by moving a selection downward through a list of emails. Interaction with the delete button 165 causes the computer vision system 110 to communicate a signal to the delete task of the email program (as application 195), which can delete a selected email in response. Interaction with the close window button 166 causes the computer vision system to send a signal to the close task of the email program, as application 195, causes the email program to close.

In an exemplary embodiment, the buttons 161-166 are portions of the visible artifact and interactions and control information for the portions can be separately taught. In another embodiment, the buttons 161-166 are visible artifacts themselves. In the example of FIG. 1, the buttons 161-166 have zero-dimensional types associated with them. In other words, a button 161-166 has two states: “pressed” by an interaction and “not pressed” when there is no interaction.

It should be noted that recognized interactions are used by the computer vision system 110. What this means is that, for the examples of the button 161-166, the user teaches the computer vision system 110 as to what interactions are to be recognized to cause corresponding control information. For instance, a user could teach the computer vision system 110 so that an interaction of moving a hand 167 across the image 160 would not be a recognized interaction, but that moving a hand 167 across part of the image 160 and stopping the hand above a given one of the buttons 161-166 for a predetermined time would be a recognized action for the given button.

The grid pad 170 is a recognized visible artifact the location of which has been determined automatically in an exemplary embodiment. Additionally, the user can perform a teaching process allows the computer vision system 110 to determine information (e.g., data representative of the outline and colors of the grid pad 170) to allow the computer vision system 110 to locate and recognize the visible artifact. The grid pad 170 is an example of a visible artifact that can generate control information with a two-dimensional type for certain recognized interactions associated therewith. The computer vision system 110 can determine a location on the grid pad 170 and produce a two-dimensional output (e.g., having X and Y values) suitable for communicating to the application 195. For instance, the application 195 could be a drafting package and the two-dimensional output could be used in a task to increase or decrease size of an object on the screen. In this example, there are two supported interactions. The first supported interaction is a movement (denoted by reference 173) of a finger of hand 171 across the grid pad 170 through one or more dimensions of the grid pad 170. Illustratively, the point 172 produced by the end of the finger of the hand 171 is used to determine control information. This interaction will cause the computer vision system 110 to produce control information having two values. A second supported interaction is a zero-dimensional interaction defined by having the finger or other portion of the hand 171 stop in area 175. This causes the computer vision system 110 to produce control information of a reset command, which can be useful (for instance) to cause the size of the object on the screen to return to a default size. In this case, two different interactions result in two different sets of control information. Another example of two different interactions for one visual artifact would be to have a button generating a one-dimensional signal corresponding to a distance of a fingertip from the button as well as to a touch of the button.

As another example, the same interaction can be associated with one recognized visible artifact, yet cause different control information to be produced, or control information to be mapped to a different task, depending on location of the recognized visible artifact or the state of the application 195. For example, the two small note papers 135, 180 can have control information mapped to different applications. Illustratively, the small note paper 180 could have a recognized interaction associated with the small note paper 180 that will cause control information to be sent to an ignore phone message task of a telephone application 195. That task will then simply ignore a phone message and terminate a ringing phone call (e.g., or send the phone message to an answering service). Alternatively, the small note paper 135 could have a recognized interaction associated with the small note paper 135 that will cause control information to be sent to a start scroll bar task of an application 195 having a scroll bar, so that the application 195 can determine that the scroll bar of the application 195 has focus and is about to be moved

Scroll bar 140 is a physical device having a slider 141 that communicates with and may be slid in groove 142. The computer vision system 110 will examine the slider 141 to determine movement. Movement of the slider 141 is a recognized interaction for the scroll bar 140, and the computer vision system 110 produces control information that is one-dimensional. The type associated with the scroll bar 140 and the previously performed user training defines movement of the slider 141 in the scroll bar 140 as having one-dimensional control information (e.g., a single value) to be communicated to the application 195.

The image 190 is also a scroll bar having a slider 191. When a human performs an interaction with the scroll bar of image 190 by placing a hand 192 over the slider 191, the computer vision system 110 can produce control information having one-dimension. A message could be sent to an application 195 having a scroll function (a task of the application 195), so that the application 195 can determine that the scroll bar of the application has been moved. The message will have a one-dimensional value associated therewith.

Thus, FIG. 1 shows that a number of different recognized visible artifacts and interactions and types of control information associated with each of the visible artifacts (or portions thereof). Although not shown, three-dimensional types may be associated with a visible artifact.

As also described in reference to FIG. 1, a visible artifact may have several types of control information associated with the visible artifact and the computer vision system 100 can generate associated values in response to different recognized interactions with the visible artifact. For example, the computer vision system 110 may generate a binary, zero-dimensional value as control information in response to a touch of a given visible artifact and may generate a one-dimensional value as part of the control information in response to a finger slid along the same visible artifact. A circular visible artifact could also have an associated a two-dimensional interaction where one dimension of the control information corresponds to the angular position of a fingertip, and the other corresponds to the distance of that fingertip.

Turning now to FIG. 2, an exemplary computer vision system 110 is shown in accordance with an exemplary embodiment of the present invention. Computer vision system 110 comprises a processor 205 coupled to a memory 210. The memory comprises a recognized visible artifact database 215, a visible artifact locator module 220 that produces visible artifact information 230, an activity locator 235 that produces activity information 240, a recognized interaction database 245, an interaction detector 250 that produces interaction information 255, a camera interface 260, a control database 270, a control output module 275 that produces control information 280, a training module 285, a mapping output module 290, and a mapping database 295. As those skilled in the art know, the various modules and databases described herein may be combined or further subdivided into additional modules and databases. FIG. 2 is merely exemplary. Additionally, the application 195 may reside in a separate computer system (not shown), and a network interface (not shown), for instance, may be used to communicate control information 280 to the application 195.

The training module 285 is a module used during training of the computer vision system 110. An illustrative method for training the computer vision system 110 is shown below in reference to FIG. 3. During training, the training module 285 creates or updates the recognized visible artifact database 215, the recognized interaction database 245, and the control database 270, and the mapping database 295. Recognized visible artifact database 215 contains information so that the visible artifact locator module 220 can recognize the visible artifacts associated with interactions. Recognized visible artifact database 215 contains information about visual artifacts known to the system, the shape or color or both of the visual artifacts, and any markings the visible artifacts may have which will help the visible artifact to be recognized. A reference that uses a quadrangle-shaped panel as a visible artifact and that describes how the panel is found is U.S. Patent Application No. US 2003/0004678, by Zhang et al., filed on Jun. 18, 2001, the disclosure of which is hereby incorporated by reference. The recognized visible artifact database 215 will typically be populated in advance with a set of recognized visible artifacts which the system 110 can detect any time the visible artifacts are in the field of view of the camera (not shown in FIG. 2). The recognized visible artifact database 215 may also be populated by the training module 285 with information about which visual artifacts to expect in the current circumstances, and possibly information about new visual artifacts, previously unknown to the system 110, and introduced to the system 110 by the user.

The interaction database 245 contains information so that the interaction detector module 250 can recognize interactions defined by a user to be associated with a visible artifact, for example if a button should respond to just a touch, or to the distance of the finger from the button as well. The control database 270 contains information so that the control output module 275 can produce control information 280 based on a recognized visible artifact or a portion thereof (e.g., defined by visible artifact information 230), a recognized interaction (e.g., defined by interaction information 255). This database determines what type of control signal is generated, and how the interaction information is used to generate the control signal. The mapping database contains information so that the control information can be sent to the correct part of the correct application.

The camera interface 260 supplies video on connection 261, can be provided information, such as zoom and focus parameters, on connection 261. The camera interface 260 can also generate signals to control the camera 125 (see FIG. 1) at the request of the system 110, i.e., moving the camera 125 to view a particular visible artifact. Although a single connection 261 is shown, multiple connections can be included. The visible artifact locator module 220 examines video on connection 261 for visible artifacts and uses the recognized visible artifact database 215 to determine recognized visible artifacts. Visible artifact information 230 is created by the visible artifact locator module 220 and allows the activity locator module 235 and the interaction detector module 250 to be aware that a recognized visible artifact has been found and a region in an image the visible artifact is located, in order for that region to be searched for interactions.

The computer vision system 110 can work in conjunction with, if desired, a system such as that described by C. Pinhanez, entitled “Multiple-Surface Display Projector With Interactive Input Capability,” U.S. Pat. No. 6,431,711, the disclosure of which is hereby incorporated by reference. The Pinhanez patent describes a system able to project an image onto any surface in a room and distort the image before projection so that a projected version of the image will not be distorted. The computer vision system 110 would then recognize the projected elements, allowing interaction with them. In an exemplary embodiment, the present invention would be an alternative to the vision system described in that patent.

The activity locator 235 determines activities that occur in the video provided by the camera interface 260, and the activity locator 235 will typically also track those activities through techniques known to those skilled in the art. The activity location produces activity information 240, which is used by the interaction detector module 250 to determine recognized interactions. The activity information 240 can be of various configurations familiar to one skilled in the art of visual recognition. The interaction detector module 250 uses this activity information 240 and the recognized interaction database 245 to determine which activities are recognized interactions. Typically, there will many activities performed in a defined area 115 (see FIG. 1), and only some of the activities are within predetermined distances from recognized visible artifacts or have other characteristics in order to qualify as interactions with recognized visible artifacts. Generally, only some of the interactions with recognized visible artifacts will be recognized interactions, and the interaction detector module 250 will produce interaction information 255 for these recognized interactions. Such interaction information 255 could include, for instance, information of the detection of a particular interaction, and any information defining that interaction. For example, an interaction with grid 170 of FIG. 1 would typically include information about where the fingertip was located within the grid. An interaction with slider 190 of FIG. 1 would need to include information about where on the slider the user was pointing. The interaction detector module 250 uses the visible artifact information 230 in order to help the computer vision system 110 determine when an interaction takes place.

A reference describing specifics of the vision algorithms useful for the activity locator 235 or the interaction detector 250 is Kjeldsen et al., “Interacting with Steerable Projected Displays,” Fifth Int'l Conf. on Automatic Face and Gesture Recognition (2002) the disclosure of which is hereby incorporated by reference.

The control output module 275 uses the interaction information 255 of a recognized interaction and information in the control database 270 in order to produce control information 280, which may then be communicated to a task of application 195 by way of the mapping module 290. The interaction information 255 typically would comprise the type of interaction (e.g., touch, wave through, near miss) and parameters describing the interaction (e.g., the distance and direction from the visual artifact, the speed and direction of the motion). For example, the distance (extracted in interaction detector 250) of a fingertip from an artifact, could be converted by the control output module 275 to one of the values of the control information 280. As part of that conversion, the absolute image or real world distance of the fingertip might be converted to a different scale or coordinate system, depending on information in control database 270. The control database 270 allows the control output module 275 to correlate a recognized visible artifact with a recognized interaction and generate control information of a specific type for the recognized interaction. In one exemplary embodiment, the type of control information to be generated by an artifact is stored in the control database 270. In another embodiment, the type of control information to be generated can be stored in the recognized interaction database 245 and the interaction information 255 will contain only information needed to generate those control values.

The control information 280 comprises information suitable for use with a task of the application 195. In accordance with the information in control database 270, the control information 280 will comprise certain parameters, including at least an appropriate number of values corresponding to a type for zero, one, two, or three-dimensional types. Thus, a parameter of a control signal in control information 280 could be a zero-dimensional signal indicating one of two states. The control information 280 would then comprise at least a value indicating which of the two states the recognized interaction represents.

Other parameters can also be included in the control information 280. For example, the one or more values corresponding to the control information types can be “packaged” in messages suitable for use by the application 195. Illustratively, such messages could include mouse commands having two-dimensional location data, or other programming or Application Programmer Interface (API) methods, as is known in the art.

The mapping module 290 maps the control information 280 to a task in an application 195 by using the mapping database 295. In an exemplary embodiment, the control information 280 includes a control signal and the mapping module 290 performs mapping from the control information to one or more tasks in the application 195.

The training module 285 is used during training so that a user can teach the computer vision system 110 which visible artifacts are recognized visible artifacts, which interactions with the recognized visible artifacts are recognized interactions, what control signal should be generated by a recognized interaction, and where that control signal should be sent. This is explained in more detail in reference to FIG. 3 below. Note that the training module 285 is shown communicating with the visible artifact information 230, the activity information 240, and the control output module 275. However, the training module may communicate with any portion of the memory 210. In particular, the training module 285 could determine information suitable for placement in one or more of the databases 215, 245, and 270 and place the information therein. The training module 285 also should be able to communicate with a user through a standard Graphical User Interface (GUI) (not shown) or through image activity on images from the camera interface 260.

For instance, in some implementations, the training module 285 will have to interpret training instructions from a user. To interpret training instructions, the training module 285 will have to know what visible artifacts have been found in an image or images from camera interface 260, as well as any interactions the user may be performing with the visible artifacts. Training instruction from a user could be either in the form of inputs from a standard GUI, or activity (including interaction sequences) extracted from the video stream (e.g. the user would place a visible artifact in the field of view, then touch labels on it, or perform stylized gestures for the camera to determine a task associated with the interaction).

As is known in the art, the techniques described herein may be distributed as an article of manufacture that itself comprises a computer-readable medium containing one or more programs, which when executed implement one or more steps of embodiments of the present invention. The computer readable medium will typically be a recordable medium (e.g., floppy disks, hard drives compact disks, or memory cards) having information on the computer readable program code means placed into memory 210.

Turning now to FIG. 3, an exemplary method 300 is shown for training a computer vision system 110 to determine recognized visible artifacts, recognized interactions for those recognized visible artifacts, control signals for the recognized interactions and destinations for the control signals according to user preferences and to produce corresponding control information suitable for communicating to an application residing in a computer system. The method 300 is shown for one visible artifact. However, the method can easily be modified to include locating multiple visible artifacts.

Method 300 begins in step 310, when the computer vision system 110 locates a visible artifact. In step 310, all visible artifacts can be cataloged, if desired. Additionally, the user can perform intervention, if necessary, so that the computer vision system 110 can locate the visible artifact. In step 320, the user places the visible artifact in a certain area (e.g., at a certain location in a defined area 115). The computer vision system 110 may track the visible artifact as the user moves the visible artifact to the certain area. Once in the area, the computer vision system 110 (e.g., under control of the training module 285) will determine information about the visible artifact suitable for placement into the recognized visible artifact database 215. Such information could include outline data (e.g., so that an outline of the visible artifact is known), location data corresponding to the visible artifact, and any other data so that the computer vision system 110 can select the visible artifact from a defined area 115. The information about the visible artifact is determined and stored in step 320. The information defines a recognized visible artifact.

In step 330, the user selects an interaction from a list of available, predetermined interactions, meaning that a particular visual artifact would have a small set of interactions associated with the visible artifact. For example, a button artifact might support a touch and proximity detection (e.g., location and angle of nearest fingertip). The user could then enable or disable these interactions, and parameterize them, usually manually through a dialog box of some kind, to tune the recognition parameters to suit the quality of motion for the user. For example, a user with a bad tremor might turn on filtering for the touch detector, so when he or she touched a button with a shaking hand only one touch event was generated, rather than several. Additionally, someone who had trouble positioning his or her hand accurately might tune the touch detector so a near miss was counted as a touch.

So for a given visual artifact, a user would specify which interactions should be associated with the visible artifact, what types are associated with the interaction (e.g., and therefore how many values are associated with the types), and what application task the control information should control. For each of these there may only be one choice, to make life simpler for the user. That way, the user could put the “Back” button visual artifact next to his or her arm, and know that interaction with the “Back” button visible artifact would generate a “Back” signal for a browser. Additionally, there could be more flexibility, so that a user could position a “Simple Button” visual artifact near them and specify that the zero-dimensional control signal generated by a touch should move the “pointer” to the next link on the web page. Furthermore, a sophisticated user could have full control, placing a “General Button” visual artifact where the user wants the visible artifact, and specifying that the two-dimensional signal generated by the angle and distance of his or her fingertip moves the pointer to the web page link closest to that direction and distance from the current location of the pointer.

In step 330, it is also possible that the system learns how to recognize an interaction by observing the user perform it. For instance, the user could perform an interaction with the recognized visible artifact and information about the interaction is placed into the recognized interaction database 245, in an exemplary embodiment. Such information could include, for example, one or more of the following: the type of interaction, the duration of the interaction; the proximity of the object (e.g., or a portion thereof) performing the interaction to the visible artifact (e.g., or a portion thereof); the speed of the object performing the interaction; and an outline of the object or other information suitable for determining whether an activity relates to the recognized visible artifact.

When the user interacts with the application 195 in step 350, the training module 285 can determine what the control information 280 should be and how to present the control information 280 in a format suitable for outputting to the application 195. As described previously, each visual artifact can generate one or more types. An application designed to work with a system using the present invention would be able to accept control inputs of these types. For example, a web browser might need zero-dimensional signals for “Back” and “Select Link” (tasks of the application), a one-dimensional signal for scrolling a page (another task of the application), and various others. A visual artifact could be “hard wired” so that a control signal (e.g., as part of control information) for the visible artifact is mapped to a particular task of an application, in which case step 350 is not performed. Alternatively, the user could specify the mapping from control signals to tasks for an application during training. Step 350 does not have to be performed if the user specifies the mapping from control signals to tasks for an application during training. However, the user could operate a task in the application and in which case step 350 may be performed so that a training module can associate the control signals with tasks for an application.

Illustratively, applications are written specifically to work with an embodiment of the present invention. In other embodiments, rewriting applications could be avoided in at least the following two ways: 1) a wrapper application could be written which translates control signals (e.g., having values corresponding to zero to three dimensions) in control information to inputs acceptable for the application; and 2) a different control scheme could be used, where the computer vision system translates the control signals into signals suitable for legacy applications directly (such as mouse events or COM controls for applications written for a particular operating system).

In step 360, control information is stored (e.g., in the control database 270). The control information allows the computer vision system 110 (e.g., the control output module 275) to determine appropriate control information based on a recognized visible artifact, and a recognized interaction with the visible artifact. Additionally, location information corresponding to the location of the recognized visible artifact in the area (e.g., defined area 115) can be stored and associated with the recognized visible artifact so that multiple recognized interactions can be associated with different locations of the same visible artifact. Furthermore, mapping information is stored in step 360.

Referring now to FIG. 4, an exemplary method 400 is shown for normal use of a computer vision system to determine recognized for a given visible artifact and to produce corresponding control information suitable for communicating to an application residing in a computer system. Typically, the computer vision system 110 locates a number of visible artifacts, but for simplicity, method 400 is written for one visible artifact.

Method 400 starts in step 405 when a visible artifact is recognized. In step 410, it is determined if the visible artifact is a recognized visible artifact. This step may be performed, in an exemplary embodiment, by the visible artifact locator module 220. The visible artifact locator module 220 can use the recognized visible artifact database 215 to determine whether a visible artifact is a recognized visible artifact. Additionally, if no changes to the system have been made, so that no visible artifacts have been moved, then steps 405 and 410 can be skipped once all recognized visible artifacts have been found, or if the visible artifact has been found and a camera has been examining the visible artifact and the visible artifact has not moved since being found. If the located visible artifact is not a recognized visible artifact (step 410=NO), then the method 400 continues in step 405. If the located visible artifact is a recognized visible artifact (step 410=YES), then the method 400 continues in step 415.

It should be noted that steps 405 and 410 can also be implemented so that one visible artifact can have different portions, where a given portion is associated with a recognized interaction. For example, the image 160 of FIG. 1 had multiple buttons 161-166 where each button was associated with a recognized interaction.

In step 415, visible artifact information (e.g., visible artifact information 230) is determined. In the example of FIG. 4, the visible artifact information includes one or more types for the visible artifact or portions thereof. In step 420, it is determined if an activity has occurred. An activity is any movement by any object, or presence of a specific object, such as the hand of a user, in an area. Typically, the activity will be determined by analysis of one or more video streams output by one or more video cameras viewing an area such as defined area 115. If there is no activity (step 420=NO), method 400 continues again prior to step 420.

If there is activity (step 420=YES), it is determined in step 425 if the activity is a recognized interaction. Such a step could be performed, in an exemplary embodiment, by an interaction detector module 250 that uses activity information 240 and a recognized interaction database 245. If the activity is not a recognized interaction (step 425=NO), method 400 continues prior to step 415. If the activity is a recognized interaction (step 425=YES), control output is generated in step 430. As described above, step 430 could be performed by control output module 275, which uses a control database 270 along with information from a visible artifact locator module 220 and an interaction detector module 250. The control information 280 (e.g., including values corresponding to zero or more dimensions corresponding to a type for the visible artifact) is then mapped (e.g., by mapping output module 290) to a particular task in an application 195, is suitable for communicating to the application 195 and is suitable for use by the task.

Thus, the present invention provides techniques for interaction-based computer interfacing using visible artifacts. Moreover, the present invention can be flexible. For example, a user could steer a projected image around an area, and the computer vision system 110 could find the projected image as a visible artifact and determine appropriate control information based on the projected image, an interaction with the projected image, and a type for the interaction. In an exemplary embodiment, a single type of control information is produced based on the projected image, an interaction with the projected image, and a type for the interaction. In another embodiment, different control information is produced based on location of the projected image in an area and based on the projected image, an interaction with the projected image, and a type for the interaction. In yet another embodiment, application state affects the mapping to a task of the application.

It is to be understood that the embodiments and variations shown and described herein are merely illustrative of the principles of this invention and that various modifications may be implemented by those skilled in the art without departing from the scope and spirit of the invention.

What is claimed is:

1. A method performed on a computer system for interaction-based computer interfacing, the method comprising the steps of:
determining if an interaction with a visible artifact is a recognized interaction; and
when the interaction is a recognized interaction, performing the following steps:
determining control information having one of a plurality of types, the control information determined by using at least the visual artifact and characteristics of the recognized interaction; and
mapping the control information to one or more tasks in an application, such that any task that requires control information of a specific type can get the control information from any visual artifact that creates control information of the specific type;
wherein the control information is suitable for use by the one or more tasks.

2. The method of claim 1, wherein the control information comprises one or more parameters determined by using the characteristics of the recognized interaction.

3. The method of claim 2, wherein the parameters comprise one or more values for the one type.

4. The method of claim 1, further comprising the steps of:
locating a given one of one or more visible artifacts in an area;
determining if the given visible artifact is a recognized visible artifact;
the step of determining if an interaction with a visible artifact is a recognized interaction further comprises the step of determining if an interaction with a recognized visible artifact is a recognized interaction; and
wherein the steps of determining control information and mapping the control information are performed when the interaction is a recognized interaction for the recognized visible artifact.

5. The method of claim 1, further comprising the step of determining the interaction, performed by an object, with the visible artifact.

6. The method of claim 1, wherein the plurality of types comprise a zero-dimensional, one-dimensional, two-dimensional, or three-dimensional type.

7. The method of claim 6, wherein the control information comprises a control signal, and wherein the step of determining control information comprises the step of determining a value for each of the dimensions for a given type, the control signal comprising the values corresponding to the dimensions for the given type.

8. The method of claim 1, wherein the visible artifact corresponds to a plurality of types such that a corresponding plurality of control information can be determined for the visible artifact.

9. The method of claim 1, wherein the visible artifact corresponds to a single type such that a corresponding single control information can be determined for the visible artifact.

10. The method of claim 1, wherein the visible artifact comprises one or more of a physical object, a printed page having images, and a projected image.

11. The method of claim 1, further comprising the step of communicating the control information to the application, and wherein the application performs the one or more tasks using the control information.

12. The method of claim 1, wherein the control information is determined by using at least the visible artifact, characteristics of the recognized interaction and contextual information.

13. The method of claim 12, wherein the contextual information comprises one or more of a location of the visible artifact and a state of the application.

14. The method of claim 1, wherein the step of mapping further comprises the step of mapping, based on contextual information, the control information to the one or more tasks in the application.

15. The method of claim 14, wherein the contextual information comprises one or more of a location of the visible artifact and a state of the application.

16. The method of claim 1, further comprising the steps of:
providing to the user indicia of one or more interactions suitable for use with a selected visible artifact;
having the user select a given one of the one or more interactions for the selected visible artifact;
storing characteristics of the given interaction, the given interaction being a recognized interaction for the selected visible artifact;
providing to the user indicia of one or more types for the selected interaction with the selected visible artifact;
having the user select a given one of the one or more types for the selected visible artifact;
storing given control information for the selected visible artifact, the given control information having the given type;
providing to the user indicia of one or more tasks, for a selected application, requiring control information of the one type;
having the user select a given one of the one or more tasks for the one type; and
storing information allowing the given control information to be mapped to the given task.

17. The method of claim 1, further comprising the steps of:
providing to the user indicia of one or more interactions suitable for use with a selected visible artifact;
having the user select a given one of the one or more interactions for the selected visible artifact;
storing characteristics of the given interaction, the given interaction being a recognized interaction for the selected visible artifact;
providing to the user indicia of one or more types for the selected interaction with the selected visible artifact;
having the user select a given one of the one or more types for the selected visible artifact;
storing given control information for the selected visible artifact, the given control information having the given type;
determining that the given control information is to be mapped to the selected visible artifact; and
storing information allowing the given control information to be mapped to the given task.

18. The method of claim 1, further comprising the step of having a user perform an interaction with the visible artifact in order to determine the recognized interaction.

19. The method of claim 1, further comprising the step of having a user operate a given one of the one or more tasks of the application in order to determine information allowing the control information to be mapped the given task.

20. An apparatus for interaction-based computer interfacing, the apparatus comprising:
a memory that stores computer-readable code; and
a processor operatively coupled to the memory, said processor configured to implement the computer-readable code, said computer-readable code configured to perform the steps of:
determining if an interaction with a visible artifact is a recognized interaction; and
when the interaction is a recognized interaction, performing the following steps:
determining control information having one of a plurality of types, the control information determined by using at least the visual artifact and characteristics of the recognized interaction; and
mapping the control information to one or more tasks in an application, such that any task that requires control information of a specific type can get the control information from any visual artifact that creates control information of the specific type.

21. An article of manufacture for interaction-based computer interfacing comprising:
a computer readable medium containing one or more programs which when executed implement the steps of:
determining if an interaction with a visible artifact is a recognized interaction; and
when the interaction is a recognized interaction, performing the following steps:
determining control information having one of a plurality of types, the control information determined by using at least the visual artifact and characteristics of the recognized interaction; and
mapping the control information to one or more tasks in an application, such that any task that requires control information of a specific type can get the control information from any visual artifact that creates control information of the specific type.
